(19) United States
(12) Patent Application Publication
(10) Pub. No.: US 2012/0090419 A1
(43) Pub. Date: Apr. 19, 2012

(54) MULTI-CYCLE BALL SCREW

(76) Inventor: CHANG-HSIN KUO, Taichung (TW)

(21) Appl. No.: 13/337,288

(22) Filed: Dec. 27, 2011

Related U.S. Application Data
(63) Continuation-in-part of application No. 12/186,495, filed on Aug. 5, 2008.

(51) Int. Cl. F16H 1/24

(52) U.S. Cl. 74/424.86

(57) ABSTRACT

A multi-cycle ball screw comprises a screw, a nut, a plurality of balls and circulating caps. The screw is provided with at least two screw helical grooves in an outer surface thereof. The nut is provided with nut helical grooves opposite to the screw helical grooves. The balls are disposed between the helical grooves of the screw and the nut. Each circulating cap is provided with a circulating groove having an opening at both ends thereof and a guiding portion between the two openings. The circulating caps are connected to two points of one screw helical groove by two openings thereof while the guiding portion thereof crosses over the other screw helical groove. By repeating this cooperation method, a multi-cycle ball screw can be formed.

This application is a continuation in part of U.S. patent application Ser. No. 12/186,495, which claims the benefit of the earlier filing date of Aug. 5, 2008. Claims 1-4 of this application correspond to claims 1-4 of the U.S. patent application Ser. No. 12/186,495.

### BACKGROUND OF THE INVENTION

1. Field of the Invention

The present invention relates to a ball screw applied for linear transmission, and more particularly to a multi-cycle ball screw.

2. Description of the Prior Art

As for the design of controlling the movement of the tables or the processing elements in the precision machines, in order to control the feed amount precisely and reduce the friction coefficient, a ball screw is commonly used for transmission. The ball screw is provided with a screw and a nut. In order to reduce the friction, the ball screw is further provided with a plurality of balls between the screw and the nut. The balls can circulate in the nut through a circulating system, though various in structures, the circulation systems are generally categorized into two types: one is outer circulation and the other is inner circulation.

The existing outer circulation type circulation systems are mostly complicated in structure, and because the path through which the balls are guided out is large, the outer diameter of the nut must be consequentially enlarged and thickened, thus causing the volume of the nut too large and increasing the fabrication cost.

The inner circulation systems can only enable the rolling elements to move between the adjacent helical grooves, so they are not applicable to the screw with multi-helical grooves. If these inner circulation type systems are compulsively applied to a ball screw with multi-helical grooves, the balls will fall off into an unexpected segment of helical groove, thus causing the circulating system to be jammed. In addition, although the inner circulation type structure has been improved to be applied to a screw with multi-helical grooves, the number of the circulating caps required for the circulating system must be increased, so as to guide the balls back to their original helical groove in a gradual manner. Moreover, the circulating caps must be symmetrically arranged at two opposite sides of the screw or four sides of the circumference of the screw, thus increasing the fabrication difficulty.

There are another two outer circulation types of ball screws as shown in FIGS. 7, 8 and 9.

The ball screw shown in FIG. 7 comprises a nut 50 and a screw 51, and the screw 51 is only defined with one helical groove 52. This type of ball screw is provided with a plurality of big balls 53 rolling in the helical groove 52 and a plurality of small balls 54 rolling along a helical flat ridge 57 which is formed along the helical groove 52. On the nut 50 are provided with a big return tube 55 for circulation of the big balls 53 and a small return tube 56 for circulation of the small balls 54. The disadvantageous effects of this ball screw are that, firstly, it has to use two types of balls and return tubes, causing inconvenience in assembly. Secondly, it only has one helical groove, and the ridge 57 is flat, so that the small balls 54 rolling on the flat ridge 57 cannot react any axial load on the nut 50. Thirdly, the return tubes 55 and 56 are disposed outside the nut, which will increase the dimension of the nut.

The ball screw shown in FIGS. 8 and 9 is similar to that shown in FIG. 7 except that the flat ridge 57 is replaced with a helical groove 57′ which is trapezoid-shaped (instead of semicircular) in cross section. As particularly shown in FIG. 9, the big balls 53′ can react the force applied approximately at 45 degrees to the nut 50′ or the screw 51′. However, the small balls 54′ are only capable of reacting the force applied vertically on the nut 50′.

In general, the outer circulation type of ball screws as shown in FIGS. 7-9 are lack of capability of reacting the axial load in the nut, however, the capability of reacting the axial load in the nut is the most important function of a ball screw.

The present invention has arisen to mitigate and/or obviate the afore-described disadvantages.

### SUMMARY OF THE INVENTION

The technical problems to be solved are as described below:

The existing inner circulation systems are not applicable to the screw with multi-helical grooves and only applicable to the screw with a single helical groove, if they are compulsively applied to a ball screw with multi-helical grooves, the balls will fall off into an unexpected segment of helical groove, thus causing the circulating system to be jammed; in addition, although some designs can be used in the screw with multi-helical grooves, the number of the circulating caps used in the circulation systems is greater, and the circulating caps must be symmetrically arranged at two opposite sides of the screw, thus increasing the fabrication difficulty.

The present invention has the following technical characteristics:

The present invention relates to a multi-cycle ball screw, which comprises: a screw being provided in an outer surface thereof with at least two screw helical grooves; a nut including nut helical grooves opposite to the screw helical grooves of the screw and being screwed on the screw; a plurality of balls being arranged between the screw helical grooves and the nut helical grooves; and a plurality of circulating caps each including a circulating groove which has an opening at both ends thereof and a guiding portion between the two openings, the two openings of one of the circulating caps being respectively linked up with two points of one screw helical groove to define a ball circulating path, while the guiding portion of the circulating cap crosses over the other screw helical groove, thus forming a multi-cycle ball screw. Moreover, each guiding portion is arranged adjacent to the outer surface of the screw, and the diameter of the cross section of the circulating groove of each circulating cap is approximately equal to the diameter of balls, so that the outer diameter of the nut can be designed to be relatively smaller, thus reducing the limitations of the outer diameter of the nut.

The multi-cycle ball screw in accordance with the present invention can offer the following functions:

The primary objective of the present invention is to provide a ball screw with doubled capability of reacting the axial load on the nut, which comprises a screw and a nut including at least two screw helical grooves and nut helical grooves, the respective screw and nut helical grooves are used together with a circulating cap, two openings of the respective circulating caps are connected between two points of the same screw and nut helical groove while the respective circulating caps crosses over different screw helical grooves, so that the balls can circulate therein. Such a manner is applicable to a screw with multi-helical grooves for widening the product application range.

The secondary objective of the present invention is to provide a multi-cycle ball screw, when the balls of the multi-cycle ball screw pass through the circulating caps, the guiding portion of the circulating groove and the surface abutting against the screw of the respective circulating caps define a narrow gap whose width is smaller than the diameter of the balls. The guiding portion of the circulating groove of the respective circulating caps is arranged adjacent to the outer surface of the screw. By such arrangements, the circulating cap and the nut can be designed to be relatively smaller, and the balls can be prevented from rolling out of other positions than the two openings, so that the balls can be kept rolling between the predetermined screw and nut helical grooves without falling off or rolling into other screw and nut helical grooves.

Another objective of the present invention is to provide a multi-cycle ball screw, every ball circulating path of which is arranged close to one another to increase the density of the ball circulating paths. Therefore, a nut can be additionally provided with multiple circulating paths to increase the strength of the ball screw, or under the condition that the number of the ball circulating paths is the same, the length of the nut can be shortened to reduce the fabricating difficulty and cost. The nut is provided with at least two nut helical grooves, the screw helical grooves which are linked up with the circulating grooves of any two adjacent circulating caps are different, and the ball circulating paths connected by the two adjacent circulating caps are substantially parallel to but not staggered with each other.

### BRIEF DESCRIPTION OF THE DRAWINGS

FIG. 1 is an assembly view of a multi-cycle ball screw in accordance with the present invention;

FIG. 2 is a front view of a circulating cap in accordance with the present invention;

FIG. 3 is a cross-sectional view of the circulating cap along the line A-A of FIG. 2 in accordance with the present invention;

FIG. 4 is an assembly view illustrating the circulation of the balls in accordance with the present invention;

FIG. 5 is a cross-sectional view illustrating how the balls circulate in the multi-cycle ball screw in accordance with the present invention;

FIG. 6 is an assembly view illustrating a nut with a single nut helical groove in the circulating of the balls in accordance with the present invention;

FIG. 7 is a cross-sectional view of a conventional outer circulation type ball screw;

FIG. 8 is a cross-sectional view of another conventional outer circulation type ball screw; and

FIG. 9 is an enlarged view of a part of FIG. 8.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

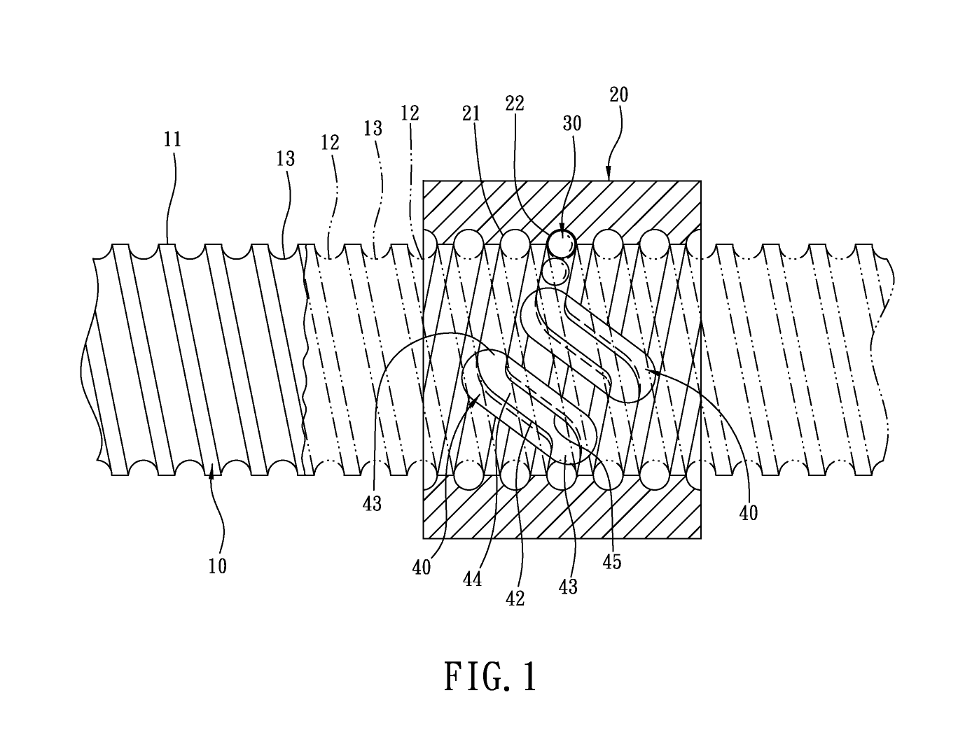

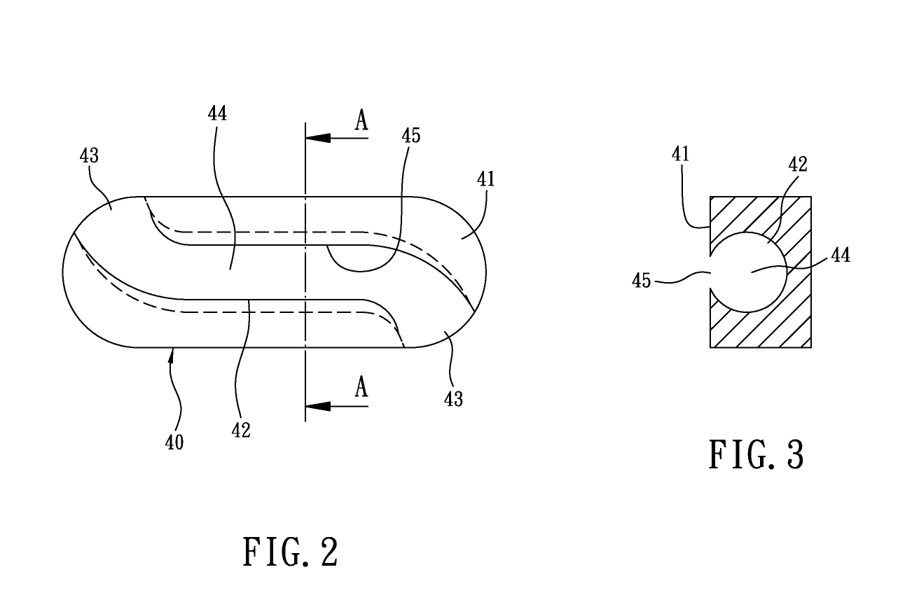

Referring to FIGS. 1-4 first, a multi-cycle ball screw in accordance with a first embodiment of the present invention comprises a screw 10, a nut 20, a plurality of balls 30 and two circulating caps 40.

The screw 10 is provided in an outer surface 11 thereof with two screw helical grooves 12, 13 which are approximatively semicircular-liked in cross section. The total number of the screw helical grooves 12, 13 is two or more.

The nut 20 includes nut helical grooves 21, 22 opposite to the screw helical grooves 12, 13. At least one of the nut helical grooves 21 or the nut helical grooves 22 is required. The nut 20 is screwed on the screw 10.

The radius of each ball 30 is approximately equal to the radius of the cross section of the respective screw helical grooves 12, 13 and nut helical grooves 21, 22. Moreover, the balls 30 are respectively arranged between the screw helical grooves 12, 13 and the nut helical grooves 21, 22.

The respective circulating caps 40 include a surface 41 abutting against the outer surface 11 of the screw 10 and a circulating groove 42 along the surface 41. The diameter of the cross section of the circulating groove 42 of the respective circulating caps 40 is approximately equal to the diameter of the respective balls 30. Each circulating groove 42 includes two openings 42 at both ends thereof and a guiding portion 44 between the two openings 42. The surface 41 of the respective circulating caps 40 is formed with a narrow gap 45 communicating with the guiding portion 44 of the circulating groove of the circulating cap 40. The width of the narrow gap 45 is smaller than the diameter of the ball 30 in such a manner that the balls 30 cannot escape from the narrow gap 45. The two openings 43 of the circulating groove 42 of one circulating cap 40 are respectively linked up with two points of the screw helical groove 12 and nut helical groove 21 to define a ball circulating path while the guiding portion 44 of this circulating cap 40 crosses over the screw helical groove 13. The two openings 43 of the circulating groove 42 of the other circulating cap 40 are respectively linked up with two points of the screw helical groove 13 and the nut helical groove 22 in such a manner that the guiding portion 40 of this circulating cap 40 crosses over the screw helical groove 12.

The guiding portion 44 of the circulating groove 42 of each circulating cap 40 is arranged adjacent to the outer surface 11 of the screw 10, and the diameter of the cross section of the circulating groove 42 of the circulating cap 40 is bigger than the diameter of the ball 30 and smaller than 1.25 times of the diameter of the ball 30, so that the outer diameter of the nut can be designed to be relatively smaller.

Furthermore, in the multi-cycle ball screw of the present invention, the respective nut helical grooves 21, 22 employ one circulating cap 40 for circulation of the balls 30. The screw helical grooves linked up with the circulating grooves of any two adjacent circulating caps 40 are different, and they are respectively the screw helical groove 12 and the screw helical groove 13. A passage defined by the screw helical groove 12 and the nut helical groove 21 is connected to the circulating groove 42 of one circulating cap 40, and the circulating groove 42 is then re-connected to the passage defined by the screw helical groove 12 and the nut helical groove 21. A passage defined by the screw helical groove 13 and the nut helical groove 22 is connected to the circulating groove 42 of the other circulating cap 40, and the circulating groove 42 is then re-connected to the passage defined by the screw helical groove 13 and the nut helical groove 22. Moreover, the ball circulating paths connected by two adjacent circulating caps are parallel to but not staggered with each other in such a manner that every ball circulating path of the nut is arranged close to one another to increase the density of the ball circulating path. Therefore, a nut can be additionally provided with some ball circulating paths to increase the strength of the ball screw, or under the condition that the number of the circulating paths is the same, the length of the nut can be shortened to reduce the nut fabrication difficulty and cost.

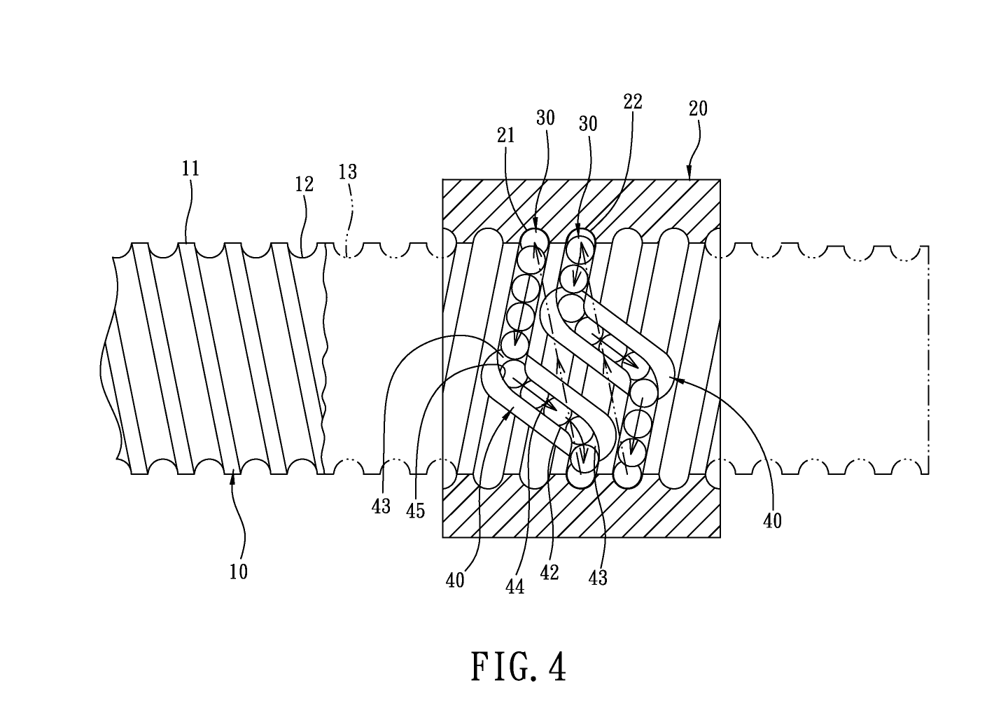

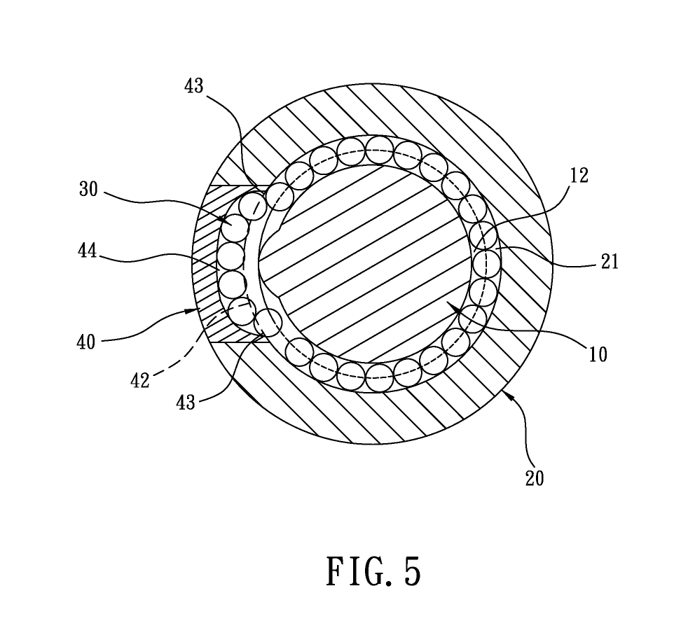

As shown in FIGS. 4-5, rotating the screw 10 or the nut 20 can make the balls 30 roll between the screw helical groove 12 and nut helical groove 20 or between the screw helical groove 13 and nut helical groove 22. The balls 30 will roll into the circulating cap 40 from one opening 43 and then roll through the guiding portion 44 to cross over the opposite screw helical groove 13, in other words, the balls 30 between the screw helical groove 12 and the nut helical groove 21 cross over the screw helical groove 13, and the balls between the screw helical groove 13 and the nut helical groove 22 cross over the screw helical groove 12. Finally, the balls 30 will roll out of the other opening 43 and then return to the front portion of the travel of their respective screw helical grooves 12, 13 and nut helical grooves 21, 22 for continuing rolling back to the rear portion of the travel of the their respective screw helical grooves 12, 13 and nut helical grooves 21, 22 and re-enter into their respective circulating grooves 42 to realize circulation. Although the screw 10 includes multiple screw helical grooves 12, 13, when the balls 30 roll along the circulating grooves 42 of the circulating caps 40, since the respective guiding portions 44 are arranged adjacent to the outer surface 11 of the screw 10, and the diameter of the cross section of the respective circulating grooves 42 is approximately equal to the diameter of the balls 30, the balls 30 almost roll along the outer surface 11 of the screw 10. As a result of this, the outer diameter of the nut can be designed to be relatively smaller.

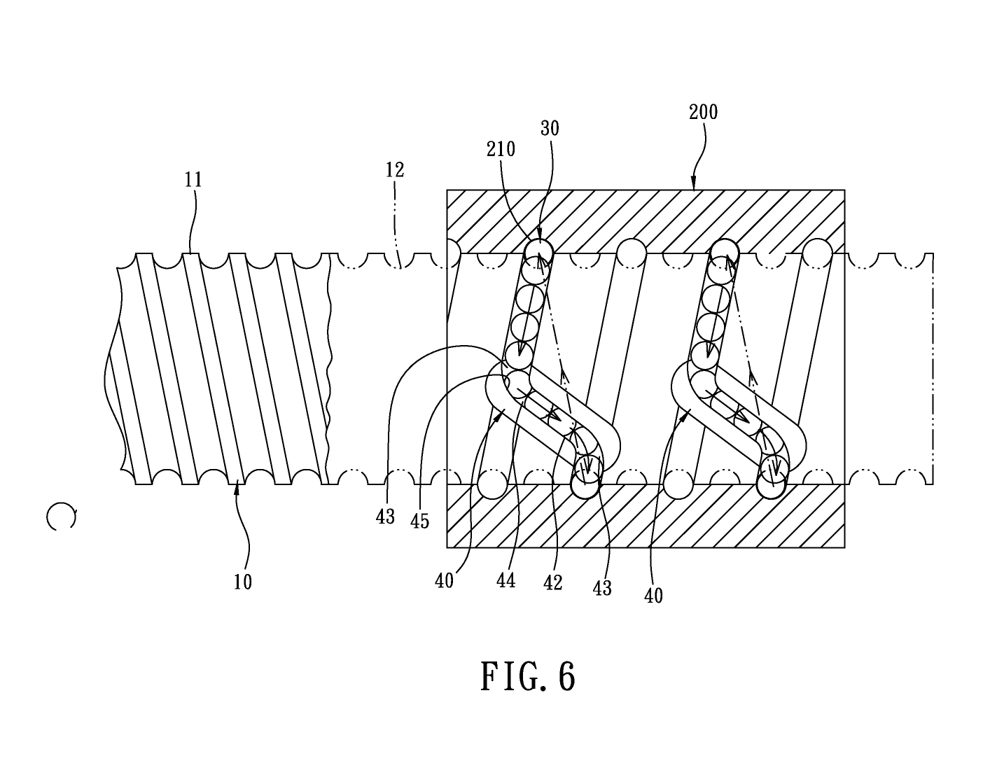

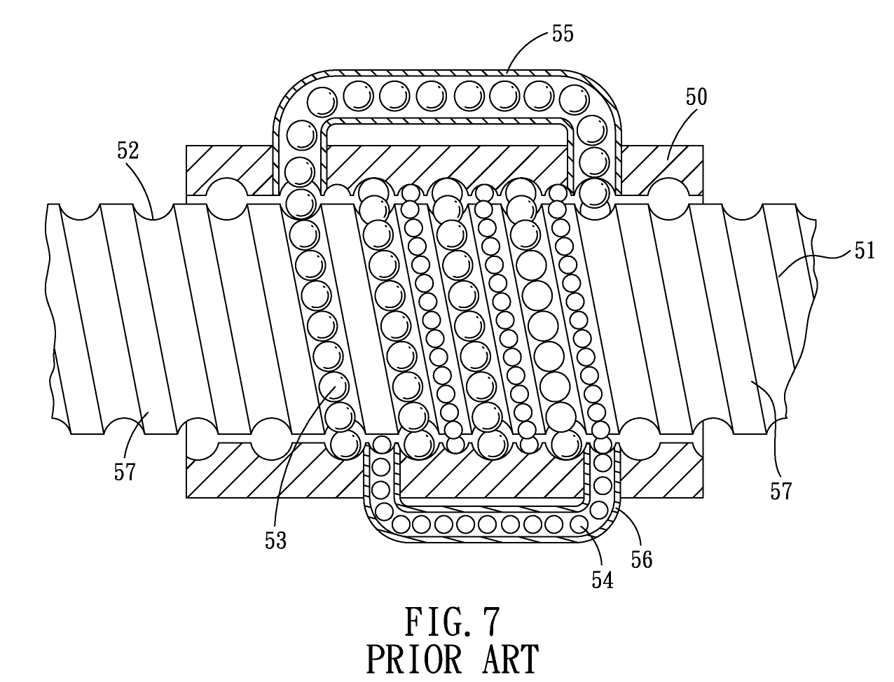

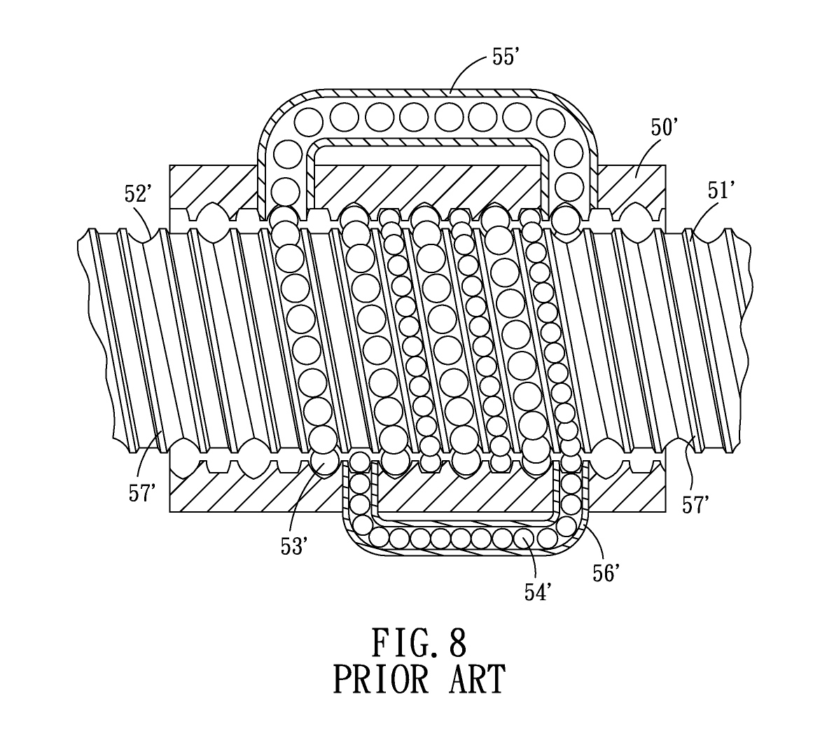

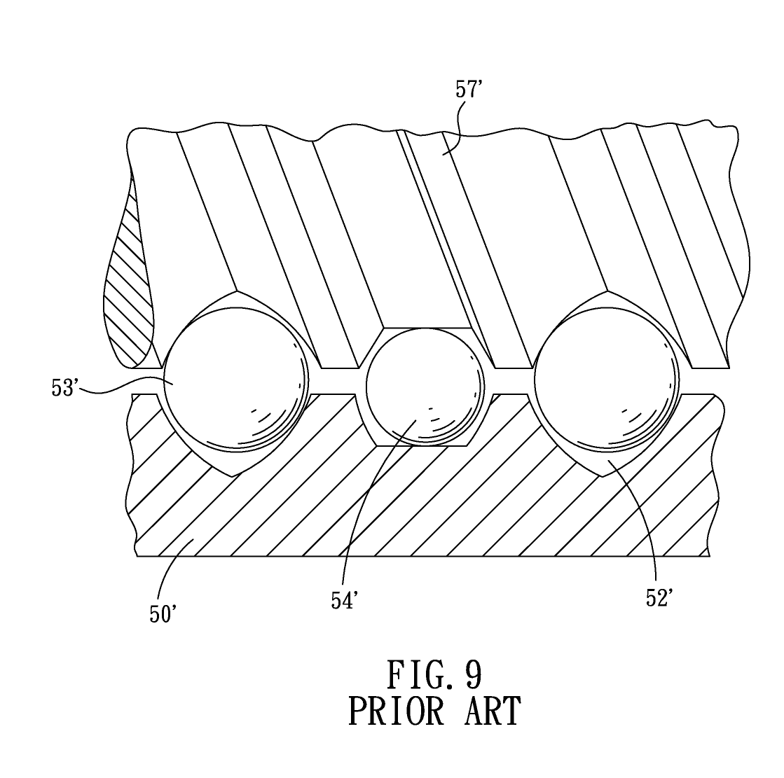

Additionally, as shown in FIG. 6, a multi-cycle ball screw in accordance with a second embodiment of the present invention comprises a screw 10, a nut 200, a plurality of balls 30 and two circulating caps 40.

The screw 10 is provided in an outer surface 11 thereof with two screw helical grooves 12, 13 which are approximately semicircular-liked in cross section.

The nut 200 includes a single nut helical groove 210 for cooperating with one of the screw helical grooves 12, 13, and the nut 200 is screwed on the screw 10.

The radius of the respective balls 30 is approximately equal to the radius of the cross section of the screw helical groove 12 or the nut helical groove 210. The respective balls 30 are arranged between the screw helical groove 12 and the nut helical groove 210.

The respective circulating caps 40 utilize one surface 41 thereof to abut against the outer surface 11 of the screw 10. Each circulating cap 40 includes a circulating groove 42 having an opening 43 at both ends thereof and a guiding portion 44 between the two openings 43. The surface 41 of the respective circulating caps 40 is formed with a narrow gap 45 communicating with the guiding portion 44 of the circulating groove 42 of the circulating cap 40. The width of narrow gap 45 is smaller than the diameter of the respective balls 30. Two openings 43 of the circulating groove 42 of each circulating cap 40 are respectively connected to the screw helical groove 12 and the nut helical groove 210 while the guiding portion 44 crosses over the screw helical groove 13.

As known from the above embodiments of the present invention, the multi-cycle ball screw in accordance with the present invention has the following advantages:

1. Although the screw 10 and the nut 20 include at least two screw helical grooves 12, 13 and nut helical grooves 21, 22, a corresponding number of circulating caps 40 are arranged on different screw helical grooves 12, 13 and nut helical grooves 21, 22, while the two openings 43 of the respective circulating caps 40 are connected to the same screw helical grooves 12, 13 and nut helical grooves 21, 22 in such a manner that the respective circulating caps 40 cross over the different screw helical grooves 12, 13 and are connected between different portions of the same screw helical groove 12 or 13 and the nut helical groove 21 or 22, so that the balls 30 can circulate between the same screw helical groove 12 or 13 and the nut helical groove 21 or 22. Such a circulating system can be applied to a screw 10 with multi-helical grooves, thus increasing the application range. Furthermore, with the arrangement of the two helical grooves 12, 13, the capability of the present invention for reacting the axial force applied on the nut is doubled.

2. The surface 41 of the respective circulating caps 40 is formed with a narrow gap 45 communicating with the guiding portion 44 of the circulating groove of the circulating cap 40, the width of the narrow gap 45 is smaller than the diameter of the balls 30, and the respective guiding portions 44 are arranged adjacent to the outer surface 11 of the screw 10. Such a structure design can reduce the limitations of the circulating cap and nut 20 to make the circulating cap 40 and nut 20 relatively smaller and prevent the balls 30 from rolling out of other positions than the two openings 43, so that the balls 30 can be retained in the predetermined screw helical grooves 12, 13 and the nut helical grooves 21, 22 without falling off or rolling into other screw helical grooves 12, 13 and nut helical grooves 21, 22.

3. Every ball circulating path of the nut of the present invention is arranged close to one another to increase the density of the ball circulating path, so that one nut can be additionally provided with multiple ball circulating paths to increase the strength of the ball screw, or under the condition that the number of the ball circulating paths is the same, the length of the nut of the present invention can be shortened to reduce the nut fabrication difficulty and cost.

While we have shown and described various embodiments in accordance with the present invention, it is clear to those skilled in the art that further embodiments may be made without departing from the scope of the present invention.

What is claimed is:

1. A multi-cycle ball screw comprising:
a screw being provided in an outer surface thereof with at least two screw helical grooves which are semicircular in cross section;
a nut including nut helical grooves opposite to the screw helical grooves of the screw, the nut helical grooves of the nut being semicircular in cross section, the nut being screwed on the screw;
a plurality of balls arranged between the screw helical grooves and the nut helical grooves, and the balls being the same size; and
a plurality of circulating caps disposed on the nut and each being formed with a circulating groove, each circulating groove including an opening at both ends thereof and a guiding portion between the two openings; characterized in that:
the respective circulating caps each include a surface abutting against the outer surface of the screw;
the two openings of one of the circulating caps are respectively linked up with two points of one screw helical groove to define a ball circulating path, while the guiding portion of the circulating cap crosses over the other screw helical groove, and a diameter of a cross section of the circulating groove of the circulating cap is approximately equal to a diameter of the balls;
the screw helical grooves can be increased in number to increase an capability of reacting an axial load on the screw.

2. The multi-cycle ball screw as claimed in claim 1, wherein the surface of the respective circulating caps, which abuts against the outer surface of the screw, is formed with a narrow gap communicating with the guiding portion of the circulating groove of the circulating cap, a width of the narrow gap is smaller than the diameter of the balls.

3. The multi-cycle ball screw as claimed in claim 1, wherein the diameter of a cross section of the circulating groove of the respective circulating caps is bigger than the diameter of the balls and smaller than 1.25 times of the diameter of the balls.

4. The multi-cycle ball screw as claimed in claim 1, wherein the nut includes at least two nut helical grooves, the screw helical grooves, which are linked up with the circulating grooves of any two adjacent circulating caps are different, and the ball circulating paths connected by the two adjacent circulating caps are parallel to but not staggered with each other.
